(19) United States
(12) Patent Application Publication
(10) Pub. No.: US 2025/0137201 A1
(43) Pub. Date: May 1, 2025

(54) ANTI-MYOPIA PAPER SHEET

(71) Applicant: GANSU YUDA PRINTING MATERIALS CO., LTD., WUWEI (CN)

(72) Inventors: PING CAO, WUWEI (CN); YONGZHI CAO, WUWEI (CN)

(21) Appl. No.: 18/933,186

(22) Filed: Oct. 31, 2024

(30) Foreign Application Priority Data
Nov. 1, 2023 (CN) 202311441035.4

(51) Int. Cl. D21H 17/67; D21C 3/06; D21C 9/12; D21H 21/28

(52) U.S. Cl. CPC D21H 17/67; D21C 3/06; D21C 9/12; D21H 21/28

(57) ABSTRACT

Provided is an anti-myopia paper sheet capable of effectively preventing eyestrain during reading or writing and reducing a reflectance factor of page reflected light, belonging to the field of stationery products. A number of graphic color blocks are printed all over a printed area for writing of the paper sheet, and each graphic color block is a graphic color block combination of any two colors of light yellow, light green, or light blue. A wavelength of reflected light in the printed area ranges from 538 nm to 590 nm, the brightness ranges from 58% to 72%, and a reflectance factor at 400 nm ranges from 48% to 60%. A page in the printed area has color purity ranging from 6% to 18%. The stimulation of full-frequency light to eyes is effectively prevented, and thus the myopia prevention is achieved.

### CROSS-REFERENCE TO RELATED APPLICATION

This patent application claims the benefit and priority of Chinese Patent Application No. 202311441035.4, filed with the China National Intellectual Property Administration on Nov. 1, 2023, the disclosure of which is incorporated by reference herein in its entirety as part of the present application.

### TECHNICAL FIELD

The present disclosure belongs to the field of stationery products, and in particular to an anti-myopia paper sheet.

### BACKGROUND

Due to the harm to the eyes caused by the increasing use of electronic products, the incidence of myopia among students remains high. The latest survey on the physical health of primary and secondary schools in China shows that the myopia rates of primary school students, middle school students and college students are 22.75%, 55.22% and 76.74%, respectively. How to effectively reduce the incidence of myopia of the students has become an urgent social problem. Moreover, myopia cannot be cured in medicine, but can only be corrected. Many industries and professions have requirements for eyesight, so myopia restricts the studies and employment fields of a large cohort of people. For the medical problem of myopia, what the public can do is to prevent myopia. In the past, some methods for preventing myopia, such as using instruments and medicines, were extremely inconvenient to use, expensive and ineffective, and were difficult to change the passive situation of frequent myopia. The majority of students and parents are also eager to have more simple, economical and effective myopia prevention products.

The invention patent (No. CN101596819A) provides an anti-myopia book, and an ink line coating for printing transverse or longitudinal lines has a line width of 0.076 mm to 0.9 mm. A wavelength of the reflection spectrum of the page ranges from 510 nm to 580 nm. The anti-myopia book has a certain myopia prevention effect, the reflectance factor of the page reflected light is reduced by increasing the roughness of a printed surface of the page, and thus the stimulation of the page reflected light to the vision is reduced, the visual fatigue is alleviated, and myopia is prevented more effectively. However, there is still room for improvement in this scheme.

### SUMMARY

An objective of the present disclosure is to provide an anti-myopia paper sheet capable of effectively preventing eyestrain during reading or writing and reducing a reflectance factor of page reflected light.

The technical solution of the present disclosure is as follows:

The present disclosure provides anti-myopia paper sheet. A number of graphic color blocks are printed all over a printed area for writing of the paper sheet, and the graphic color block is a combination of graphic color blocks of any two colors of light yellow, light green or light blue. A wavelength of reflected light in the printed area ranges from 538 nm to 590 nm, the brightness and whiteness ranges from 58% to 72%, a reflectance factor at 400 nm ranges from 48% to 60%, and a page in the printed area has color purity ranging from 6% to 18%.

Further, the graphic color blocks of two colors are irregular geometric color blocks.

Further, the graphic color blocks of two colors are regular geometric color blocks.

Further, the geometric color blocks of each color are regularly and orderly distributed in a whole printed area for writing, and the geometric color blocks of two adjacent colors do not overlap with each other.

Further, the geometric color blocks of each color are regularly and orderly distributed in the whole printed area for writing, and partial areas of the geometric color blocks of the two adjacent colors overlap with each other.

Further, a printing material for the printed area is antibacterial and bacteriostatic ink.

Further, one of printing plates for printing the color blocks of two colors is a positive printing plate.

The present disclosure further provides a printing method of an anti-myopia paper sheet, including the following steps:
Step one: typesetting and plate making: preparing a printing plate with geometric shapes, selecting geometric color blocks of one color to prepare a positive film, and geometric color blocks of another color to prepare a negative film, where the positive film and the negative film are complementary;
Step two: after ink is blended, printing to make color purity of a page in a printed area reach 6%-18%;
Step three: printing: printing the blended ink on a writing paper sheet alternately in the order of first printing the positive film and then printing the negative film, where the positive film is printed in a positive film area, and a negative film is printed in a negative film area; and
Step four: binding printed paper sheets into a book.

Further, a chart, text or a function grid is also printed in a printed area for ink printing in Step three.

The present disclosure has the beneficial effects that:

By printing irregularly arranged color blocks of light yellow and color blocks of light blue, a wavelength of the reflected light of the printed area ranges from 538 nm to 590 nm, a reflectance factor and reflectivity at 400 nm are reduced, and the brightness of the paper sheet is also reduced at the same time. The stimulation of full-frequency light to eyes is effectively prevented, and thus the effect of myopia prevention is achieved. Under the condition of not overusing an electronic product, the anti-myopia paper sheet has the effects of gradually recovering pseudo-myopia, and avoiding the progression of true myopia.

The inventor entrusted the National Paper Quality Supervision and Inspection Center to inspect relevant books for the anti-myopia paper sheet provided by the present disclosure and related anti-myopia book pages, with an inspection report as follows:

The national intellectual invention patent (publication No. CN101596819A) is an anti-myopia book (No. 2008-760). The ink line coating of the anti-myopia book is composed of transverse lines and longitudinal lines, the line widths of which are fixed, and the reflectance factor of the anti-myopia book at 400 nm is 25.5%.

The wavelength of the reflected light in the printed area ranges from 538 nm to 590 nm, the brightness ranges from 58% to 72%, the reflectance factor at 400 nm ranges from 48% to 60%, and the color purity of a page in the printed area ranges from 6% to 18%.

The anti-myopia paper sheet adopted by the present disclosure makes full use of the advantages of the color block of light blue, the color block of light yellow and the color block of light green in color perception. Any two of the color block of light blue, the color block of light yellow and the color block of light green is used to reduce the reflectance factor of the page reflected light, and the alternate printing of two different color blocks is used to promote the subtle changes of ciliary muscles of eyes when a user perceives the color perception function during writing or reading, such that the eyestrain caused by elongation of axis oculi during ciliary muscle movement can be avoided, and a comfortable color vision and visual environment is provided for the user. As the user is in the dynamic eye-using environment with good perception, the elasticity of the ciliary muscle is increased during the movement perceived by the ciliary muscle, and it is not easy to cause myopia.

When the eyes are overused at close range, the ciliary muscles in the eyeball continue to contract, and fail to relax for a long time, which leads to spasm of accommodation to form a myopia state. The balance of the expansion and contraction of muscles attached to the surface of eyeball is disturbed, which aggravates the oppression on the eyeball, thus making eyeball muscles elongated to form a myopic state. Multiple color blocks are combined, complemented, and printed in the functional area of the page of the book to prevent harmful light from stimulating the eyes. After the eyes perceive the color of the color blocks, the eye nerves are active and sensitive, which makes the ciliary muscles involuntarily contract and relax to promote the subtle movement of the eye nerves, which effectively overcomes the objective factors that cause myopia in the writing process. The color intensity of the color block is achieved by the change of the color purity, and the color purity ranges from 6% and 18% to control the color vision and visual comfort. For example, the most significant feature of the increase of the color purity is that the color darkens. Therefore, when reducing color purity, the ink absorbs some light-sensitive components of illumination, and the reflected energy is weakened. Similarly, the human eye is most sensitive to green at present, which is also related to the eye environmental factors. Therefore, when the writing page provided by the anti-myopia writing page for the user perceives the color of the color block, the brain is excited, and the brain instructs the eye nerves to be active to keep the ciliary muscle contracting and relaxing, thus achieving the purpose of preventing myopia.

### BRIEF DESCRIPTION OF THE DRAWINGS

FIG. 1 is a structural diagram of a paper sheet according to the present disclosure;

FIG. 2 is a partial enlarged view of Embodiment 1 of the present disclosure;

FIG. 3 is a partial enlarged view of Embodiment 2 of the present disclosure;

FIG. 4 is a partial enlarged view of Embodiment 3 of the present disclosure.

The reference numerals are as follows: 1—printed area for writing; 2—color block of one color; 3—color block of another color.

### DETAILED DESCRIPTION OF THE EMBODIMENTS

### Embodiment 1

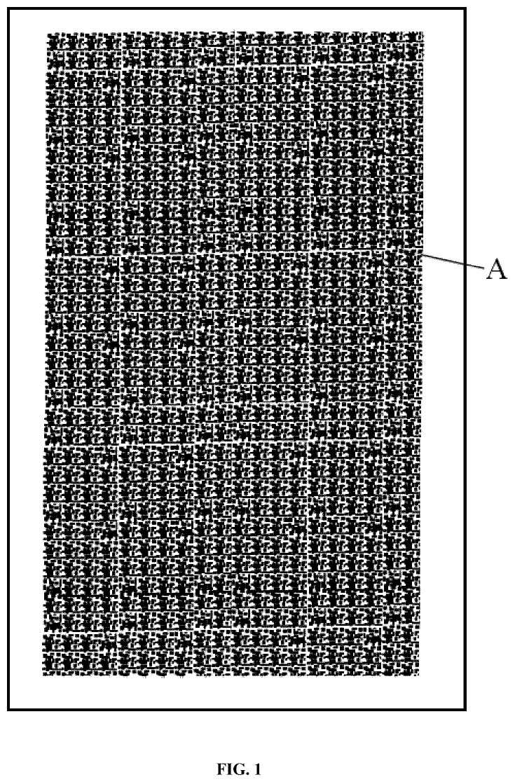

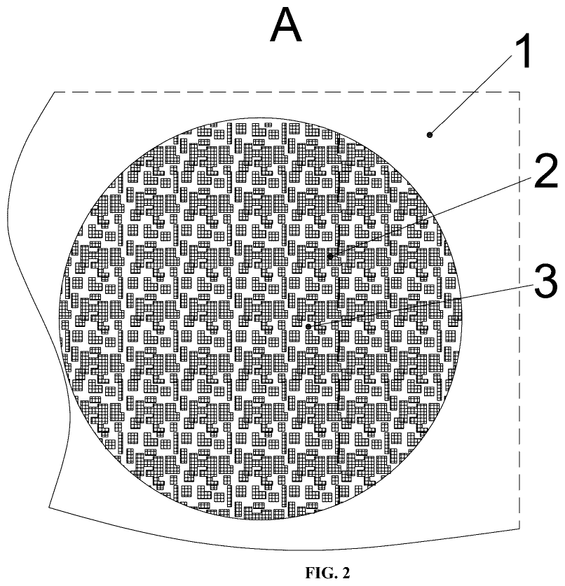

As shown in FIG. 1 to FIG. 2, the present disclosure provides anti-myopia paper sheet. A number of graphic color blocks are printed all over a printed area for writing of the paper sheet, and the graphic color block is a combination of graphic color blocks of any two colors of light yellow, light green or light blue. A wavelength of reflected light in the printed area ranges from 538 nm to 590 nm, the brightness and whiteness ranges from 58% to 72%, a reflectance factor at 400 nm ranges from 48% to 60%, and a page in the printed area has color purity ranging from 6% to 18%.

The geometric color blocks of two colors are irregular geometric color blocks, the color blocks of the two colors are arranged complementarily like a QR (quick response) code, and the geometric color blocks of the two colors are spread all over the printed area for writing in disorder. In FIG. 2, 2 represents a color block of one color (light yellow color block), 3 represents a color block of another color (light blue color block), and a printing material used in the printed area is antibacterial and bacteriostatic ink.

In this embodiment, the adjacent geometric color blocks of two colors may also partially overlap with each other.

A printing method of an anti-myopia paper sheet includes the following steps:
Step one: typesetting and plate making: preparing a printing plate with geometric shapes, selecting geometric color blocks of one color to prepare a positive film, and geometric color blocks of another color to prepare a negative film, where the positive film and the negative film are complementary;
Step two: after ink is blended, printing to make color purity of a page in a printed area reach 6%-18%; Step three: printing: printing the blended ink on a writing paper sheet alternately in the order of first printing the positive film and then printing the negative film, where the positive film is printed in a positive film area, and a negative film is printed in a negative film area; and
Step four: binding printed paper sheets into a book.

Further, a chart, text or a function grid is also printed in a printed area for ink printing in Step three.

In this embodiment, a main wavelength of a front side of the paper sheet is 567 nm, a main wavelength of a back side of the paper sheet is 566 nm, a reflectance factor of the front side at 400 nm is 52.1%, a reflectance factor of the back side at 500 nm is 72.9%, the brightness of the front side is 64.4%, and the brightness of the back side is 64.8%.

### Embodiment 2

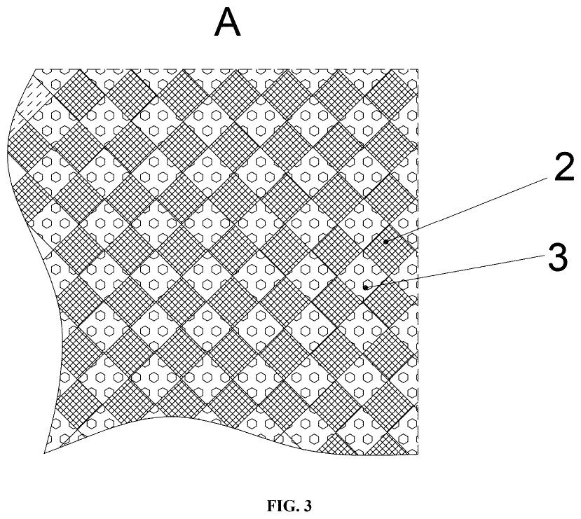

Other steps in this embodiment are the same as those in Embodiment 1, the difference is that the geometric color blocks of the two colors in this embodiment are regular geometric color blocks, and the geometric color blocks of the two colors are orderly spread all over the whole printed area for writing, as shown in FIG. 3.

In this embodiment, a main wavelength of a front side of the paper sheet is 569 nm, a main wavelength of a back side of the paper sheet is 569 nm, a reflectance factor of the front side at 400 nm is 50.3%, a reflectance factor of the back side at 500 nm is 75.7%, the brightness of the front side is 63.7%, and the brightness of the back side is 74.6%.

### Embodiment 3

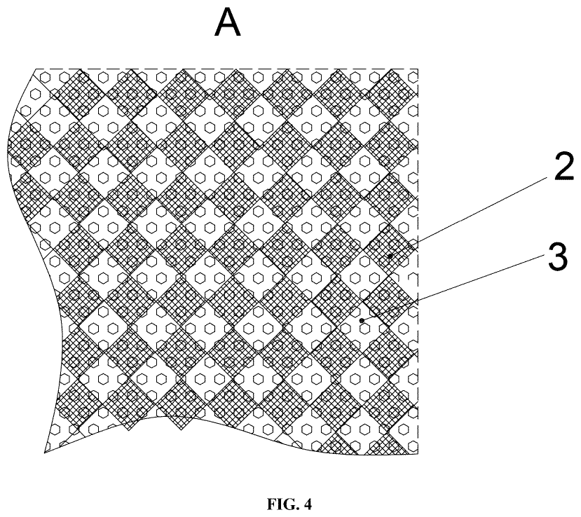

Other steps in this embodiment are the same as those in Embodiment 1, the difference is that the geometric color blocks of the two colors in this embodiment are regular geometric color blocks, and the geometric color blocks of the two colors are orderly spread all over the whole printed area for writing, and partially overlap with each other, as shown in FIG. 4.

In this embodiment, a main wavelength of a front side of the paper sheet is 568 nm, a main wavelength of a back side of the paper sheet is 569 nm, a reflectance factor of the front side at 400 nm is 54.3%, a reflectance factor of the back side at 500 nm is 73.6%, the brightness of the front side is 68.1%, and the brightness of the back side is 69.2%.

In the present disclosure, any two of the geometric color block of light yellow, the geometric color lock of light green and the geometric color block of light blue can be arbitrarily selected and combined. The color block may be an irregular geometric color block, or a regular geometric color block. In addition to those shown in the Embodiments and accompanying drawings, the color block may also be other regular or irregular geometric color blocks.

The regular geometric color block may be various geometric shapes such as a square, a rectangle, and a triangle, and the geometric color blocks of the adjacent colors may also partially overlap with each other.

What is claimed is:

1. An anti-myopia paper sheet, wherein a number of graphic color blocks are printed all over a printed area for writing of the paper sheet, and the graphic color block is a combination of graphic color blocks of any two colors of light yellow, light green or light blue; a wavelength of reflected light in the printed area ranges from 538 nm to 590 nm, the brightness ranges from 58% to 72%, a reflectance factor at 400 nm ranges from 48% to 60%, and a page in the printed area has color purity ranging from 6% to 18%.

2. The anti-myopia paper sheet according to claim 1, wherein the graphic color blocks of two colors are irregular geometric color blocks.

3. The anti-myopia paper sheet according to claim 1, wherein the graphic color blocks of two colors are regular geometric color blocks.

4. The anti-myopia paper sheet according to claim 3, wherein the geometric color blocks of each color are regularly and orderly distributed in a whole printed area for writing, and the geometric color blocks of two adjacent colors do not overlap with each other.

5. The anti-myopia paper sheet according to claim 3, wherein the geometric color blocks of each color are regularly and orderly distributed in the whole printed area for writing, and partial areas of the geometric color blocks of the two adjacent colors overlap with each other.

6. The anti-myopia paper sheet according to claim 1, wherein a printing material for the printed area is antibacterial and bacteriostatic ink.

7. The anti-myopia paper sheet according to claim 1, wherein one of printing plates for printing the color blocks of two colors is a positive printing plate.

8. A printing method of an anti-myopia paper sheet, comprising the following steps:
Step one: typesetting and plate making: preparing a printing plate with geometric shapes, selecting geometric color blocks of one color to prepare a positive film, and geometric color blocks of another color to prepare a negative film, wherein the positive film and the negative film are complementary;
Step two: after ink is blended, printing to make color purity of a page in a printed area reach 6%-18%;
Step three: printing: printing the blended ink on a writing paper sheet alternately in the order of first printing the positive film and then printing the negative film, wherein the positive film is printed in a positive film area, and a negative film is printed in a negative film area; and
Step four: binding printed paper sheets into a book.

9. The printing method of an anti-myopia paper sheet according to claim 8, wherein a chart, text or a function grid is also printed in a printed area for ink printing in Step three.

10. The anti-myopia paper sheet according to claim 2, wherein one of printing plates for printing the color blocks of two colors is a positive printing plate.

11. The anti-myopia paper sheet according to claim 3, wherein one of printing plates for printing the color blocks of two colors is a positive printing plate.

12. The anti-myopia paper sheet according to claim 4, wherein one of printing plates for printing the color blocks of two colors is a positive printing plate.

13. The anti-myopia paper sheet according to claim 5, wherein one of printing plates for printing the color blocks of two colors is a positive printing plate.

14. The anti-myopia paper sheet according to claim 6, wherein one of printing plates for printing the color blocks of two colors is a positive printing plate.
